(19) United States
(12) Patent Application Publication
(10) Pub. No.: US 2017/0350452 A1
(43) Pub. Date: Dec. 7, 2017

(54) BEARING ASSEMBLY WITH EXPANDED OUTER DIAMETER

(71) Applicant: Schaeffler Technologies AG & Co. KG, Herzogenaurach (DE)

(72) Inventors: Shakeel Shaikh, Windsor (CA); Renato Rodrigues de Paula, Erlangen (DE)

(73) Assignee: Schaeffler Technologies AG & Co. KG, Herzogenaurach (DE)

(21) Appl. No.: 15/611,174

(22) Filed: Jun. 1, 2017

Related U.S. Application Data
(60) Provisional application No. 62/344,658, filed on Jun. 2, 2016.

(51) Int. Cl. F16C 35/04; F16C 43/04; F16C 19/06

(52) U.S. Cl. CPC F16C 35/04; F16C 19/06; F16C 43/04

(57) ABSTRACT

Bearing assemblies and methods of forming the same are disclosed. The bearing assembly may include an outer bearing ring having a first outer diameter and defining an outer race and a radially outer surface. A radial extension may be coupled to the radially outer surface of the outer bearing ring to expand an outer diameter of the bearing assembly from the first outer diameter to a larger second outer diameter. The second outer diameter may be configured to correspond to a diameter of a housing cavity that is larger than the first diameter such that the bearing assembly can be coupled to the housing (e.g., press fit into the housing). The radial extension may be over-molded or press fit onto the outer bearing ring. The radial extension may be formed of a material less dense than the outer bearing ring, such as a polymer or elastomer.

### CROSS-REFERENCE TO RELATED APPLICATIONS

This application claims the benefit under 35 U.S.C. §119(e) of U.S. Provisional Patent Application No. 62/344,658, filed Jun. 2, 2016, which application is incorporated in its entirety herein by reference.

### FIELD

The present disclosure relates generally to bearing assemblies with an expanded outer diameter, for example, to fit into a housing designed for a larger bearing assembly.

### BACKGROUND

Bearing assemblies generally include a plurality of rolling elements sandwiched between opposing raceways in bearing rings. The rolling elements may take many forms, such as spherical balls, rollers, tapered rollers, barrel-shaped spherical rollers, or others. Bearing assemblies are used in a wide range of applications. For example, in vehicles, bearing assemblies may be used for supporting an intermediate drive shaft (IDS) or a drive shaft (prop shaft). The IDS or prop shaft is typically supported by a bearing assembly, which is in turn supported on an outer housing. When used to support an IDS, the outer housing may be mounted to an engine block. When used to support prop shaft, the outer housing (e.g., a bracket with over-molded rubber) may be mounted to the vehicle chassis body.

### BRIEF SUMMARY

In at least one embodiment, a bearing assembly is provided. The bearing assembly may include an inner bearing ring defining an inner race and a bore surface; an outer bearing ring having a first outer diameter and defining an outer race and a radially outer surface; a plurality of rolling elements supported between the inner race and the outer race; and a radial extension coupled to the radially outer surface of the outer bearing ring, the radial extension expanding an outer diameter of the bearing assembly from the first outer diameter to a larger second outer diameter; wherein the second outer diameter is configured to correspond to a diameter of a housing cavity that is larger than the first diameter such that the bearing assembly can be assembled with the housing.

The second outer diameter may be configured to match the diameter of the housing cavity such that the bearing assembly can be press fit into the housing cavity. The radial extension may have a density that is less than that of the outer bearing ring. In one embodiment, the radial extension is formed of a polymer or an elastomer. The radial extension may be over-molded or press fit onto the outer bearing ring. In one embodiment, the outer bearing ring has one or more grooves defined in the radially outer surface and the radial extension extends into the one or more grooves. In another embodiment, an outer surface of the radial extension has a textured surface profile including a plurality of raised portions and a plurality of depressed portions. An outer surface of the radial extension may have one or more grooves defined therein.

In at least one embodiment, a method is provided. The method may include applying a radial extension to a radially outer surface of an outer bearing ring of a bearing assembly; and the radial extension expanding an outer diameter of the bearing assembly from a first outer diameter to a larger second diameter that is configured to correspond to a diameter of a housing cavity that is larger than the first diameter such that the bearing assembly can be coupled to the housing.

The radial extension may be applied to the radially outer surface by over-molding. In another embodiment, the radial extension may be applied to the radially outer surface by press fitting the radial extension onto the radially outer surface. The radial extension may be formed of rubber and may be stretched onto the radially outer surface. Prior to applying the radial extension to the radially outer surface, the method may include increasing a surface area of the radially outer surface. Increasing the surface area may include roughening the radially outer surface and/or forming grooves in the radially outer surface. An outer surface of the radial extension may include at least one raised portion and at least one depressed portion. The method may further include press fitting the bearing assembly having the radial extension applied thereon into the housing cavity.

In at least one embodiment, a bearing and housing assembly is provided. The assembly may include a housing defining a cavity having a bearing diameter; and a bearing assembly comprising: an inner bearing ring defining an inner race and a bore surface; an outer bearing ring having a first outer diameter and defining an outer race and a radially outer surface; a plurality of roller elements supported between the inner race and the outer race; and a radial extension coupled to the radially outer surface of the outer bearing ring, the radial extension expanding an outer diameter of the bearing assembly from the first outer diameter to a larger second outer diameter; wherein the second outer diameter corresponds to the bearing diameter of the housing cavity and the bearing assembly is press fit into the housing cavity.

In one embodiment, the housing includes a deformable element extending around the periphery of the cavity and an outer surface of the radial extension includes at least one raised portion and at least one depressed portion. When the bearing assembly is press fit into the housing cavity, the deformable element may be configured to extend into the at least one depressed portion in the outer surface of the radial extension.

### BRIEF DESCRIPTION OF THE DRAWINGS

The nature and mode of operation of the disclosure will now be more fully described in the following detailed description of the disclosure taken with the accompanying drawing figures, in which:

FIG. 1 illustrates a cross-section of a bearing assembly, according to an embodiment;

FIG. 2 illustrates a cross-section of the bearing assembly of FIG. 1 inserted into a housing, according to an embodiment;

FIG. 3 illustrates a cross-section of a bearing assembly including a radial extension, according to an embodiment;

FIG. 4 illustrates a perspective view of a bearing assembly prior to the addition of a radial extension, according to an embodiment;

FIG. 5 illustrates a perspective view of the bearing assembly of FIG. 4 with the radial extension applied, according to an embodiment;

FIG. 6 illustrates the bearing assembly of FIG. 3 inserted into a housing, according to an embodiment;

FIG. 7A illustrates a perspective view of a bearing assembly including a radial extension with a smooth surface, according to an embodiment;

FIG. 7B illustrates a cross-section of the bearing assembly of FIG. 7A;

FIG. 8A illustrates a perspective view of a bearing assembly including a radial extension with a textured surface, according to an embodiment;

FIG. 8B illustrates a cross-section of the bearing assembly of FIG. 8A;

FIG. 9A illustrates a perspective view of a bearing assembly including a radial extension with a ribbed surface, according to an embodiment;

FIG. 9B illustrates a cross-section of the bearing assembly of FIG. 9A;

FIG. 10A illustrates a perspective view of a bearing assembly including a radial extension with a grooved surface, according to an embodiment; and

FIG. 10B illustrates a cross-section of the bearing assembly of FIG. 10A.

### DETAILED DESCRIPTION

At the outset, it should be appreciated that like drawing numbers appearing in different drawing views identify identical, or functionally similar, structural elements. Furthermore, it is understood that this disclosure is not limited only to the particular embodiments, methodology, materials and modifications described herein, and as such may, of course, vary. As those of ordinary skill in the art will understand, various features illustrated and described with reference to any one of the figures can be combined with features illustrated in one or more other figures to produce embodiments that are not explicitly illustrated or described.

The terminology used herein is for the purpose of describing particular aspects only, and is not intended to limit the scope of the present disclosure, which is limited only by the appended claims. It is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments.

Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

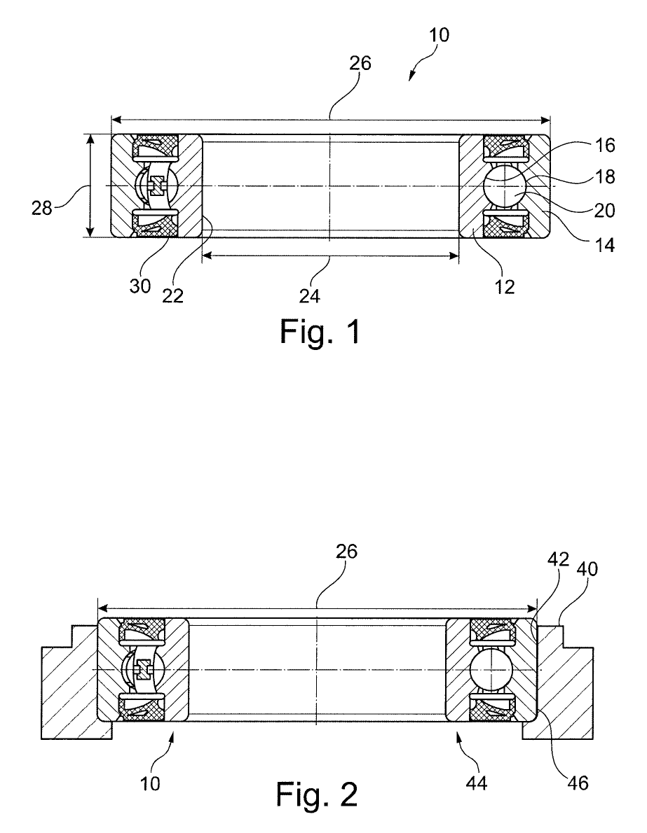

With reference to FIG. 1, a bearing assembly 10 is shown. The bearing assembly 10 may include an inner bearing ring 12 and an outer bearing ring 14. The inner bearing ring 12 may define an inner race 16 and the outer bearing ring 14 may define an outer race 18. One or more (e.g., a plurality) of rolling elements 20 may be disposed and/or supported between the inner race 16 and the outer race 18 when the bearing assembly 10 is assembled. In the embodiment shown, the rolling elements 20 are spherical (e.g., ball bearings). However, any suitable type of rolling element may be used, such as roller bearings or others. Non-limiting examples of roller bearings may include cylindrical, cone-shaped/tapered, barrel shaped, or others.

The inner bearing ring 12 of the bearing assembly 10 may define a bore 22 having a bore size or diameter 24. The bore size 24 may correspond to a size or diameter of a shaft, such as an IDS or prop shaft (not shown), to which the bearing assembly may be coupled. Non-limiting examples of bore sizes may include 30 mm, 35 mm, or 40 mm, however, the bearing assembly 10 may define any suitable bore size. In one embodiment, the bore size may be from 25 to 45 mm, or any sub-range therein, such as 30 to 40 mm. The outer bearing ring 14 may define an outer diameter (OD) 26 of the bearing assembly 10. The bearing assembly 10 may also have a width 28. In the embodiment shown, the bearing assembly 10 includes in-board seals 30 to reduce or mitigate the ingress of contaminants. However, in-board seals are not required, and the bearing assembly 10 may be an open bearing, have a separate shielding member, or any other configuration.

With reference to FIG. 2, the outer bearing ring 14 of the bearing assembly is shown supported on a housing 40. The housing 40 may include a wall 42 that defines a cavity or envelope 44. The cavity 44 may be sized and shaped such that it matches or corresponds to the outer diameter 26 of the bearing assembly. The bearing assembly 10 may be inserted into the cavity 44 (e.g., by a press fit) such that a radially outer surface 46 of the bearing assembly 10 (e.g., the outer surface of the outer bearing ring 14) is in contact with the wall 42 of the housing 40. As described above, the housing 40 may be mounted to another component, such as an engine block.

In general, when a bearing assembly is to be inserted into a housing, a bearing assembly is chosen or designed to fit a particular housing having pre-determined dimensions. Typically, a bearing assembly is chosen/designed that has the appropriate bore size for the application and an OD that matches the size of the cavity in the housing. However, it has been found that this may lead to using bearing assemblies that are larger than necessary. This may result in the use of bearing assemblies that are heavier and/or higher in cost than a smaller bearing assembly that also meets the load requirements for the application.

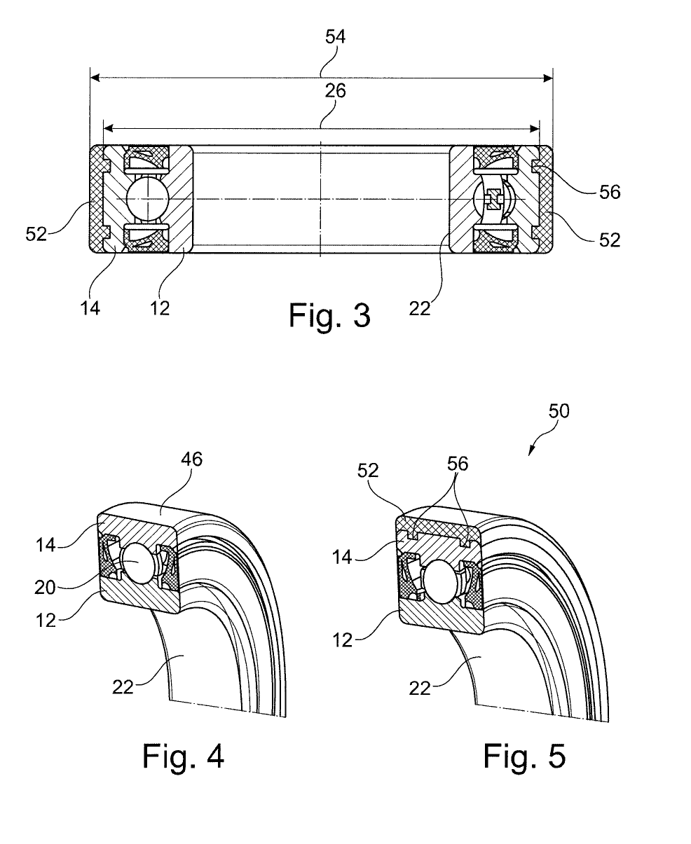

With reference to FIG. 3, an extended bearing assembly 50 is disclosed that has an expanded outer diameter. Accordingly, the extended bearing assembly 50 may be inserted into a housing that is designed and configured to receive a larger bearing assembly. This may allow a smaller bearing assembly, which may be lighter and/or lower cost, to be used in place of a larger bearing assembly.

The extended bearing assembly 50 may have the same or similar components to the bearing assembly 10, and are identified with like numerals. However, the outer diameter (OD) 26 of the bearing assembly 50 is smaller than that of the bearing assembly 10. In at least one embodiment, the extended bearing assembly 50 includes a radial extension 52. The radial extension 52 may effectively increase the outer diameter of the bearing assembly from OD 26 to an expanded OD 54. The expanded OD 54 may match or correspond to the size of a housing cavity (e.g., such as cavity 44 of housing 40), such that the bearing assembly 50 forms a press fit with the housing.

The radial extension 52 may be attached to or formed on the bearing (e.g., the outer bearing ring 14) during the production of the bearing assembly or in a separate step thereafter. In some embodiments, the radial extension 52 may be over-molded onto the bearing assembly, such as over the outer bearing ring 14. In these embodiments, the radial extension 52 may be a plastic or polymer material. Non-limiting examples of polymers that may be used may include polyamides, such as nylon (e.g., PA6/PA66/PA46) or PPA, other thermoplastics, such as PPS or PAEK, thermoplastic elastomers (e.g., TPE or TPS), or others. The polymers may or may not include a reinforcing material, such as glass or carbon fibers. In another embodiment, the over-molded radial extension 52 may be formed of rubber or another elastomer. In other embodiments, the radial extension 52 may be press fit onto the outer bearing ring 14, which may include stretching it over the outer bearing ring 14. In these embodiments, the radial extension 52 may be formed of an elastic or flexible material, such as rubber or another elastomer. In addition to over-molding, press fitting, or stretching, any other technique to expand the diameter of the bearing assembly may be used for forming the radial extension 52. For example, if only a small increase in OD is desired, a coating may be applied to the outer bearing ring 14. In another example, a ring of material having the desired extra thickness may be attached or secured to the outer bearing ring 14, for example, using an adhesive or fasteners. While the radial extension 52 has been described as a polymer, any other suitable material maybe use used, such as metals or ceramics. In one embodiment, the radial extension 52 may be formed of a material (or materials, if a composite) that is less dense than the outer bearing ring 14 (e.g., a metal, such as steel). Accordingly, the addition of the radial extension 52 may be lighter than a bearing assembly with a larger/thicker outer bearing ring.

With reference to FIGS. 4 and 5, perspective views are shown of a bearing assembly before (FIG. 4) and after (FIG. 5) the addition of the radial extension 52. In FIG. 4, the radially outer surface 46 of the outer bearing ring 14 forms the outermost surface of the bearing assembly. As described above, the OD of the bearing assembly (prior to adding the radial extension 52) may be smaller than the diameter of a housing cavity for a certain application, but the bearing assembly may be otherwise capable for the application (e.g., sufficient load and longevity/fatigue properties). It has been discovered that by adding a radial extension 52 to the bearing assembly, an extended bearing assembly 50 may be formed that will fit the diameter of the housing but also reduce weight and/or cost. The extended bearing assembly 50 may also allow for more standardization of bearing assemblies. For example, one bearing assembly design may be implemented in multiple applications by adjusting the radial extension dimensions instead of redesigning the bearing assembly itself. This may reduce the amount of resources, such as time, cost, and testing, that are associated with developing a new bearing design for each application.

In the embodiments shown in FIGS. 3 and 5, channels or grooves 56 are formed in the radially outer surface 46 of the outer bearing ring 14. These grooves 56 may be referred to as retaining features, and may increase the bonding or adhesion between the radial extension 52 and the outer bearing ring 14. There are two grooves 56 shown in the illustrated embodiments, however, there may be a single groove 56 or there may be multiple grooves 56 (e.g., two or more). In addition, while the grooves are shown as rectangular, they may have any suitable shape, such as triangular or truncated triangular. Grooves are merely an example of a retaining feature, and other types of retaining features may be used, in addition to or instead of grooves. For example, the radially outer surface 46 may be roughened to increase the surface area for the radial extension 52 to adhere to. One example of roughening may be knurling. In one embodiment, the groove(s) 56 may be roughened (e.g., knurled) to further amplify their surface area increase. The retaining features (e.g., grooves) may be formed in the outer bearing ring 14 during its production or as an intermediate step before applying the radial extension 52. The retaining features may be formed in any suitable way, such as machining (e.g., turning).

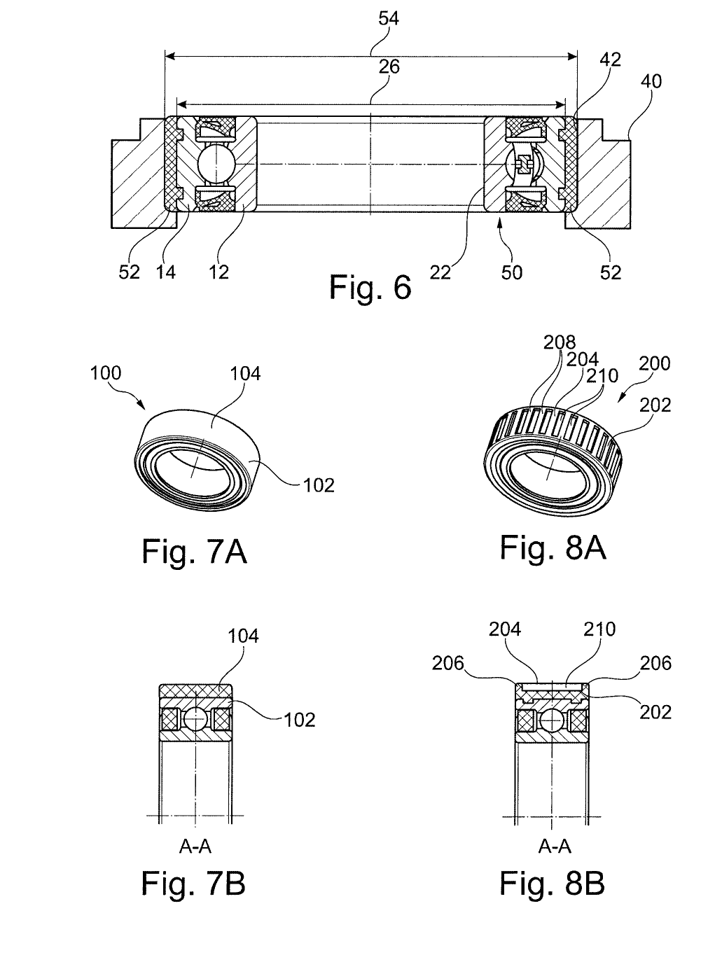

With reference to FIG. 6, the extended bearing assembly 50 is shown inserted into the housing 40. As described above, the housing 40 includes a peripheral wall 42 that defines a cavity 44 that corresponds to an outer diameter of the bearing assembly 10. The OD of the bearing assembly 50 (e.g., without the radial extension) is smaller than the OD of bearing assembly 10. But, the radial extension 52 expands the diameter of the bearing assembly 50 to an OD 54 that is the same or substantially the same as that of bearing assembly 10. Accordingly, the bearing assembly 50 may be inserted (e.g., by press fit) into the cavity 44 of the housing 40 in the same manner as bearing assembly 10. However, bearing assembly 50 may be lighter and/or less costly than bearing assembly 10 due to the use of less dense and/or lower cost materials (e.g., polymers) to increase the outer diameter.

With reference to FIGS. 7A-10B, several examples are shown of different radial extension configurations. The radial extensions may have different surface configurations or profiles. In these embodiments, the expanded OD (e.g., OD 54) may refer to the largest diameter of the radial extension. For example, for a ribbed surface profile, the OD may be measured at the peaks rather than the valleys. While several examples of surface profiles are shown, the illustrated examples are not intended to be limiting. One of ordinary skill in the art will understand, based on the present disclosure, that other profiles may be used or the profiles shown may be modified.

With reference to FIGS. 7A and 7B, a bearing assembly 100 is shown. The bearing assembly 100 includes a radial extension 102 having a smooth or flat surface profile 104. Accordingly, the surface profile 104 of the radial extension 102 may be configured as a cylinder, for example, having substantially no projections or depressions in the surface. The selection of the surface profile may depend on the application and/or the particular housing into which the bearing assembly will be inserted. For example, some housings may have a deformable element, such as a rubber portion or rubber insert (e.g. a seal or gasket) positioned around a periphery or circumference of the cavity that will receive the bearing assembly. As described above, the radial extensions may be formed of an elastomeric material, such as rubber. In these embodiments, it may be possible to eliminate the rubber lip or rim of the housing (for housings that include such rubber lips/rims). In embodiments where a deformable rubber lip/rim is present, press fitting a bearing assembly having a smooth or flat profile into a housing with a rubber rim or lip may be difficult.

With reference to FIGS. 8A-10B, several examples of bearing assemblies are shown having non-flat surface profiles that may facilitate insertion of the bearing assemblies into a housing, for example, a housing with a rubber rim or lip. By having a non-flat surface (e.g., at least one raised portion and one depressed portion), there may be gaps or depressions in the surface that may allow the rubber to deform into, thereby providing a seal and easing the insertion of the bearing assembly into the housing.

With reference to FIGS. 8A and 8B, a bearing assembly 200 is shown. The bearing assembly 200 includes a radial extension 202 having a textured surface profile 204. As used herein, a textured surface profile may be one that includes a plurality of raised portions and a plurality of depressed portions. In the embodiment shown, the edges 206 of the radial extension 202 (e.g., on either side of the width) may be raised and a plurality of spaced apart raised slats or strips 208 may extend between the edges 206. The slats 208 may extend parallel to the width of the bearing assembly (e.g., as shown) or they may be oblique to the width direction. In one embodiment, the edges 206 and the slats 208 may be co-planar. Between the spaced apart slats 208 there may be depressions or valleys 210. The cross-section of FIG. 8B is taken across a depression 210 and shows the raised edges 206 on either side thereof. When the bearing assembly 200 is inserted into a housing having a rubber (or other elastomer) rim or lip, the rubber may deform and extend into or fill the depressions 210. This may facilitate a good seal between the housing and the bearing assembly, as well as ease insertion of the bearing assembly and improve the mechanical locking between the bearing assembly and the housing.

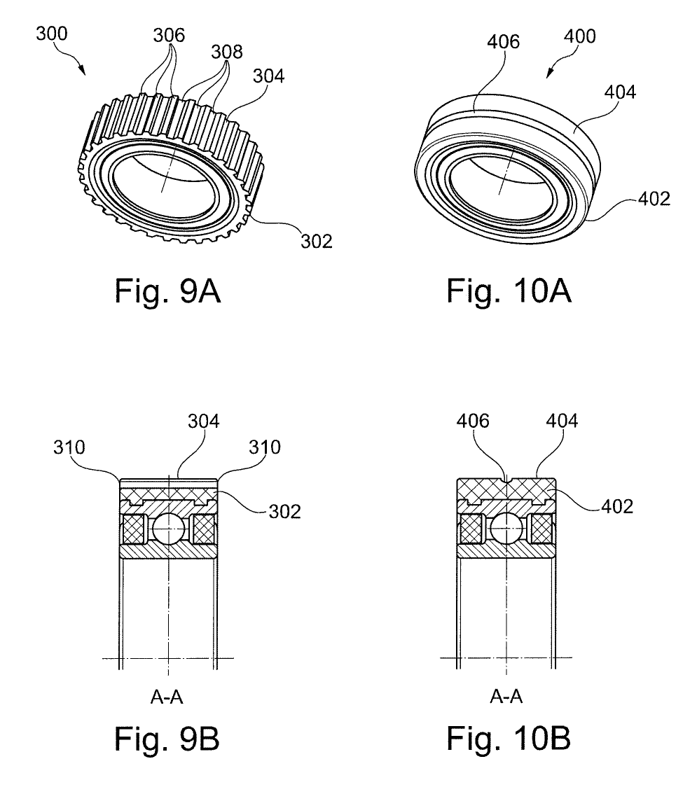

With reference to FIGS. 9A and 9B, a bearing assembly 300 is shown. The bearing assembly 300 includes a radial extension 302 having a textured surface profile 304. In the embodiment shown, the surface profile 304 includes a plurality of alternating ridges or ribs 306 and valleys or depressions 308 extending parallel to the width of the bearing assembly. However, in some embodiments, the ridges 306 and valleys 308 may be oblique to the width direction. In one embodiment, both the ridges 306 and the valleys 308 may extend a full width of the radial extension 302, from one edge 310 to the other. The ridges 306 and valleys 308 may have any suitable shape in side profile, for example, they may be formed as a square wave, triangular wave, sin wave, scalloped, or others. When the bearing assembly 300 is inserted into a housing having a rubber (or other elastomer) rim or lip, the rubber may deform and extend into or fill the valleys 308. This may facilitate a good seal between the housing and the bearing assembly, as well as ease insertion of the bearing assembly and improve the mechanical locking between the bearing assembly and the housing.

With reference to FIGS. 10A and 10B, a bearing assembly 400 is shown. The bearing assembly 400 includes a radial extension 402 having a grooved surface profile 404. The surface profile 404 may be flat or smooth, such as in FIGS. 7A and 7B, except that one or more grooves or channels 406 may be defined therein. The groove or grooves 406 may extend around a circumference of the radial extension 402, as shown. The illustrated embodiment has a single groove 406, which is optionally centered along the width of the bearing assembly. However, there may be multiple grooves 406 (e.g., two or more), which may be spaced along the width of the bearing assembly. The groove(s) 406 may extend around an entire circumference of the radial extension 402 or only a portion thereof. In one embodiment, the groove(s) 406 may be intermittent such that there are periodic gaps between grooved portions (e.g., resembling a dotted/dashed line). The groove(s) 406 may have any suitable shape, for example, it/they may be a triangular grove, square/rectangular groove, rounded/scalloped groove, truncated triangle groove, etc., or a combination thereof. When the bearing assembly 400 is inserted into a housing having a rubber (or other elastomer) rim or lip, the rubber may deform and extend into or fill the groove(s) 406. This may facilitate a good seal between the housing and the bearing assembly, as well as ease insertion of the bearing assembly and improve the mechanical locking between the bearing assembly and the housing.

Accordingly, bearing assemblies having an expanded or extended outer diameter are disclosed, as well as methods of forming the expanded diameter portion. These bearing assemblies may have numerous advantages or benefits over the traditional approach of selecting or designing a new bearing assembly for each particular housing based on the outer diameter of the outer bearing ring. The disclosed approach may allow for a single bearing assembly with a certain shaft/bore size to be used with a large variety of housings because the size/thickness of the radial extension may be changed without any changes to the bearing assembly itself. Therefore, a “custom” bearing assembly can be produced for each housing by tailoring the thickness of the radial extension, all while using s standardized bearing assembly design.

Such standardization may reduce the time and cost associated with designing a new bearing assembly from scratch. Instead, only the radial extension may need to be adjusted, for example, by changing an over-molding tool. This may be substantially easier and more cost effective than changing the design of the bearing assembly itself. In addition to cost and time savings, the use of the radial extension may also provide a significant weight reduction compared to using a larger bearing assembly. This may be particularly true when a relatively light duty bearing assembly can be used in a relatively large housing. For example, bearings used with intermediate drive shafts and propeller shafts may not require high-load bearing assemblies. Accordingly, a relatively light-load or light-duty bearing assembly may have a radial extension added (e.g., by over-molding) to increase the OD of the bearing assembly to fit a relatively large housing. If the radial extension is formed of a light weight material, such as a polymer, then significant weight reduction may be achieved.

Another benefit of the disclosed radial extensions may be an improvement in noise, vibration, and harshness (NVH). The material used for the radial extension may provide a damping effect that may reduce noise or vibration in the bearing assembly. This may be particularly true if the radial extension is formed of an elastomeric material, such as rubber. Accordingly, the disclosed expanded diameter bearing assemblies may provide streamlined engineering, cost reduction, and/or weight reduction, all without compromising the fit or function of the bearing assembly.

### Examples

In one example, a bearing assembly is being selected based on a particular housing design. The housing has a bore dimension of 40 mm, a width of 22 mm, and is configured to receive a bearing assembly with an OD of 72 mm. Conventionally, a bearing assembly would be chosen (or designed from scratch) to have a matching 40 mm bore dimension and a 72 mm OD. However, according to the present disclosure, an existing bearing assembly design may be used that has a bore dimension of 40 mm, a width of 17 mm, and an OD of 68 mm. A radial extension having a thickness of 2 mm may be applied to the bearing assembly (e.g., by over-molding) to increase the OD of the bearing assembly by 4 mm to the 72 mm required by the housing. Accordingly, a smaller bearing assembly may be used, which will reduce the bearing OD by 4 mm and width by 5 mm. In many applications, the width dimension is not a critical one, therefore a smaller width may be used without compromising the safety or performance of the bearing assembly.

In another example, a bearing assembly is being selected based on a different housing design. The housing has a bore dimension of 35 mm, a width of 18 mm, and is configured to receive a bearing assembly with an OD of 62 mm. Again, conventionally, a bearing assembly would be chosen (or designed from scratch) to have a matching 35 mm bore dimension and a 62 mm OD. However, according to the present disclosure, an existing bearing assembly design may be used that has a bore dimension of 35 mm, a width of 16.6 mm, and an OD of 55 mm. A radial extension having a thickness of 3.5 mm may be applied to the bearing assembly (e.g., by over-molding) to increase the OD of the bearing assembly by 7 mm to the 62 mm required by the housing. Accordingly, a smaller bearing assembly may be used, which will reduce the bearing OD by 7 mm and width by 1.4 mm.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A bearing assembly, comprising:
an inner bearing ring defining an inner race and a bore surface;
an outer bearing ring having a first outer diameter and defining an outer race and a radially outer surface;
a plurality of rolling elements supported between the inner race and the outer race; and
a radial extension coupled to the radially outer surface of the outer bearing ring, the radial extension expanding an outer diameter of the bearing assembly from the first outer diameter to a larger second outer diameter;
wherein the second outer diameter is configured to correspond to a diameter of a housing cavity that is larger than the first diameter such that the bearing assembly can be assembled with the housing.

2. The bearing assembly of claim 1, wherein the second outer diameter is configured to match the diameter of the housing cavity such that the bearing assembly can be press fit into the housing cavity.

3. The bearing assembly of claim 1, wherein the radial extension has a density that is less than that of the outer bearing ring.

4. The bearing assembly of claim 1, wherein the radial extension is formed of a polymer.

5. The bearing assembly of claim 1, wherein the radial extension is formed of an elastomer.

6. The bearing assembly of claim 1, wherein the radial extension is over-molded onto the outer bearing ring.

7. The bearing assembly of claim 1, wherein the radial extension is press fit onto the outer bearing ring.

8. The bearing assembly of claim 1, wherein the outer bearing ring has one or more grooves defined in the radially outer surface and the radial extension extends into the one or more grooves.

9. The bearing assembly of claim 1, wherein an outer surface of the radial extension has a textured surface profile including a plurality of raised portions and a plurality of depressed portions.

10. The bearing assembly of claim 1, wherein an outer surface of the radial extension has one or more grooves defined therein.

11. A method, comprising:
applying a radial extension to a radially outer surface of an outer bearing ring of a bearing assembly; and
the radial extension expanding an outer diameter of the bearing assembly from a first outer diameter to a larger second diameter that is configured to correspond to a diameter of a housing cavity that is larger than the first diameter such that the bearing assembly can be coupled to the housing.

12. The method of claim 11, wherein the radial extension is applied to the radially outer surface by over-molding.

13. The method of claim 11, wherein the radial extension is applied to the radially outer surface by press fitting the radial extension onto the radially outer surface.

14. The method of claim 13, wherein the radial extension is formed of rubber and is stretched onto the radially outer surface.

15. The method of claim 11, wherein prior to applying the radial extension to the radially outer surface, the method includes increasing a surface area of the radially outer surface.

16. The method of claim 15, wherein increasing the surface area includes roughening the radially outer surface and/or forming grooves in the radially outer surface.

17. The method of claim 11, wherein an outer surface of the radial extension includes at least one raised portion and at least one depressed portion.

18. The method of claim 11, further comprising press fitting the bearing assembly having the radial extension applied thereon into the housing cavity.

19. A bearing and housing assembly, comprising:
a housing defining a cavity having a bearing diameter; and
a bearing assembly comprising:
an inner bearing ring defining an inner race and a bore surface;
an outer bearing ring having a first outer diameter and defining an outer race and a radially outer surface;
a plurality of rolling elements supported between the inner race and the outer race; and
a radial extension coupled to the radially outer surface of the outer bearing ring, the radial extension expanding an outer diameter of the bearing assembly from the first outer diameter to a larger second outer diameter;
wherein the second outer diameter corresponds to the bearing diameter of the housing cavity and the bearing assembly is press fit into the housing cavity.

20. The bearing and housing assembly of claim 19, wherein the housing includes a deformable element extending around the periphery of the cavity and an outer surface of the radial extension includes at least one raised portion and at least one depressed portion;
wherein when the bearing assembly is press fit into the housing cavity, the deformable element extends into the at least one depressed portion in the outer surface of the radial extension.
